(19) United States
(12) Patent Application Publication
(10) Pub. No.: US 2010/0221129 A1
(43) Pub. Date: Sep. 2, 2010

(54) HERMETIC COMPRESSOR

(76) Inventor: Seigo Yanase, Kanagawa (JP)

Correspondence Address: WENDEROTH, LIND & PONACK L.L.P., 1030 15th Street, N.W., Suite 400 East, Washington, DC, 20005-1503, US

(21) Appl. No.: 12/096,270

(22) PCT Filed: Dec. 26, 2007
(86) PCT No.: PCT/JP2007/075377

§ 371 Date: Jun. 5, 2008

(30) Foreign Application Priority Data
Feb. 23, 2007 (JP) 2007-043243

(51) Int. Cl. F04B 39/02; F04B 35/04; F16C 19/10; F16C 35/06

(52) U.S. Cl. 417/415

(57) ABSTRACT

A hermetic compressor of the present invention includes a thrust-ball bearing having balls (168) disposed in a holder (170) in a manner that the balls (168) roll along at least two tracks (182a, 182b, 184a and 184b). The invented structure decreases the number of balls (168) that roll along each of the tracks (182a, 182b, 184a and 184b), and reduces a frequency of sliding between the balls (168) and the tracks (182a, 182b, 184a and 184b), thereby alleviating wear of the tracks.

### TECHNICAL FIELD

The present invention relates to hermetic compressors used for appliances such as refrigerators and freezers.

### BACKGROUND ART

There is a strong demand in recent years for high efficiency for reduction of power consumption, as well as low noise and high reliability of hermetic compressors used for refrigeration apparatuses such as refrigerators and freezers.

Typical hermetic compressors of this kind hitherto available have a structure provided with a thrust-ball bearing to make a shaft freely rotatable about a main axis bearing for the purpose of improving the efficiency (refer to patent document 1 for example).

Description is provided hereinafter of the conventional hermetic compressor noted above with reference to the drawings.

FIG. 7 is a vertical cross-sectional view of the conventional hermetic compressor described in patent document 1, FIG. 8 is an enlarged view of an essential portion shown in FIG. 7, and FIG. 9 is a perspective view of a conventional thrust-ball bearing.

In FIG. 7 to FIG. 9, hermetically sealed container 2 houses motor element 8 formed of stator 4 and rotor 6, compressor element 10 driven in a rotary motion by motor element 8, and lubricating oil 12 stored in a bottom part thereof. Motor element 8 and compressor element 10 are assembled into one unit to compose compressor mechanism 14, and this compressor mechanism 14 is resiliently supported by a plurality of coil springs 16 within hermetically sealed container 2.

Compressor element 10 includes shaft 26 having main shaft portion 20 and eccentric shaft portion 24 formed across flange portion 22, cylinder block 32 provided with compression chamber 30, and main shaft bearing 34 formed on cylinder block to support shaft 26. Compressor element 10 further includes piston 36 adapted to make a reciprocating motion inside compression chamber 30, and connecting mechanism 38 which connects piston 36 and eccentric shaft portion 24. In addition, compressor element 10 further includes upper race receiving surface 42 provided on lower side 39 of flange portion 22 of shaft 26 at generally perpendicular to axis 40a of main shaft portion 20, thrust sliding surface 44 provided on the upper side of main shaft bearing 34 at generally perpendicular to axis 40b of main shaft bearing 34 for supporting weights of shaft 26 and rotor 6 in the direction of gravity, and thrust-ball bearing 46 disposed between upper race receiving surface 42 and thrust sliding surface 44. The components described above thus compose the hermetic compressor of reciprocating type.

Shaft 26 has oil feeding mechanism 50, whose one end is in communication with lubricating oil 12 stored in hermetically sealed container 2, and oil feeding groove 52 which is formed in main shaft portion 20 and feeds a part of lubricating oil 12 drawn up by oil feeding mechanism 50 to thrust sliding surface 44.

Motor element 8 is formed of fixed to stator 4 located below cylinder block 32, and rotor 6 fixed to main shaft portion 20 by thermal insertion method or the like.

Thrust-ball bearing 46 includes a plurality of balls 60, holder 62 for retaining balls 60, and upper race 64 and lower race 66 placed respectively on the top and the bottom of balls 60. Upper race 64 abuts upon upper race receiving surface 42 of flange portion 22, and lower race 66 abuts upon thrust sliding surface 44.

The plurality of balls 60 are arranged along circle 76 of a given radius in holder 62 such that balls 60 trace rolling tracks 74a and 74b of identical circles on rolling surfaces 72a and 72b at the sides, where balls 60 roll, while in abutment upon upper race 64 and lower race 66.

The hermetic compressor constructed as above operates in a manner which will be described hereinafter.

When motor element 8 is energized with an external power supply (not shown in the drawings), rotor 6 rotates together with shaft 26, and a motion of eccentric shaft portion 24 is transferred to piston 36 through connecting mechanism 38. This causes piston 36 to move reciprocally inside compression chamber 30, and compressor element 10 to perform a predetermined compressing operation.

As a result, refrigerant gas is introduced into compression chamber 30 from a cooling system (not shown), compressed, and discharged again to the cooling system.

During this operation, oil feeding mechanism 50 of shaft 26 draws up lubricating oil 12, and lubricates individual sliding surfaces (not shown). A part of lubricating oil 12 is supplied to thrust sliding surface 44 via oil feeding groove 52, and lubricates thrust-ball bearing 46.

Weights of shaft 26 and rotor 6 are supported by thrust-ball bearing 46, and balls 60 roll between upper race 64 and lower race 66 while shaft 26 is rotating. This makes the torque smaller to rotate shaft 26 as compared to other structure equipped with a thrust sliding bearing. As a result, this structure can perform the compressing operation with a high efficiency since it reduces a loss in the thrust bearing, and thereby decreasing the input power.

In the above conventional structure disclosed in patent document 1, however, all of the plurality of balls 60 roll only along single track 74a on rolling surface 72a and another single track 74b on rolling surface 72b of upper race 64 and lower race 66 respectively. For this reason, when the operating time is prolonged, a frequency of sliding between balls 60 and tracks 74a, 74b increases excessively, thereby increasing abrasion wear. This results in an increase of frictional resistance due to many times of repeated rolling of balls 60 in the worn tracks 74a and 74b, thereby giving rise to a problem that the input power increases.

In addition, time from when one ball 60 rolls on a given point of tracks 74a and 74b till when the next ball 60 has passed the same point is short. Therefore, this structure prevents oil films from forming sufficiently on tracks 74a and 74b since it does not allow an enough time for lubricating oil 12 to lubricate tracks 74a and 74b. The structure thus has another problem of wear-out or exfoliating phenomena of tracks 74a and 74b as the result of increase in the frictional resistance between balls 60 and sliding surfaces of tracks 74a and 74b.

(Patent document 1: Japanese Patent Unexamined Publication, No. 2005-127305)

### DISCLOSURE OF THE INVENTION

The present invention addresses the above problems of the conventional art, and it aims to provide a hermetic compressor featuring high efficiency and high reliability by reducing wearing of rolling surfaces of an upper race and a lower race on which balls of a thrust-ball bearing roll, and by minimizing an increase of input power.

In order to resolve the above problems, the hermetic compressor of the present invention is provided with a thrust-ball bearing having a plurality of balls so that they roll along at least two tracks. Since this arrangement makes the plurality of balls roll along two or more separate tracks on rolling surfaces of both upper and lower races, the number of the balls that roll on each track is decreased, thereby reducing frequency of sliding between the balls and the tracks. The present invention thus has an advantageous effect of reducing wear of the tracks so as to prevent the balls hard to roll.

The present invention also helps lubricating oil to spread sufficiently to form an oil film over the tracks since it provides a longer time from when one ball rolls on a given point of the track till when the next ball has passed the same point. This can prevent an increase in frictional resistance of sliding interfaces between the balls and the tracks, thereby providing another advantage of reducing or avoiding wear and exfoliating phenomenon of the tracks.

In other words, the hermetic compressor of the present invention includes a hermetically sealed container storing lubricating oil therein, a motor element provided with a stator and a rotor, and a compressor element driven by the motor element and contained in the container, wherein the compressor element includes a shaft having the rotor fixed to a vertically extending main shaft portion thereof, a main shaft bearing for axially supporting the main shaft portion of the shaft, and a compression chamber a capacity of which varies with rotation of the shaft. In addition, the hermetic compressor of this invention includes the thrust-ball bearing having the plurality of balls and a holder for retaining the balls, and positioned at a thrust sliding surface to support weights of the shaft and the rotor in the direction of gravity, and the balls are arranged in a manner that they roll along at least two tracks.

Since the structure devised as above makes the plurality of balls roll along two or more separate tracks on rolling surfaces of the upper and lower races, the number of the balls that roll on each track is decreased, thereby reducing substantially the frequency of sliding between the balls and the tracks as well as their sliding distances. Accordingly, this invention can provide the hermetic compressor with high efficiency and high reliability by avoiding an increase of input power since it reduces wearing of the tracks and prevent the balls hard to roll.

### BRIEF DESCRIPTION OF DRAWINGS

FIG. 1 is a vertical cross-sectional view of a hermetic compressor according to a first exemplary embodiment of the present invention;

FIG. 2 is an enlarged view of an essential portion of the hermetic compressor according to the first exemplary embodiment of the present invention;

FIG. 3 is a perspective view of a thrust-ball bearing according to the first exemplary embodiment of the present invention;

FIG. 4 is a vertical cross-sectional view of a hermetic compressor according to a second exemplary embodiment of the present invention;

FIG. 5 is an enlarged view of an essential portion of the hermetic compressor according to the second exemplary embodiment of the present invention;

FIG. 6 is a perspective view of a thrust-ball bearing according to the second exemplary embodiment of the present invention;

FIG. 7 is a vertical cross-sectional view of a conventional hermetic compressor;

FIG. 8 is an enlarged view of an essential portion of the conventional hermetic compressor; and

FIG. 9 is a perspective view of a thrust-ball bearing of the conventional hermetic compressor.

### DETAILED DESCRIPTION OF PREFERRED EMBODIMENTS

Description will be provided hereinafter of an exemplary embodiment of the present invention by referring to the drawings. In the accompanying drawings, individual components are shown with their dimensions enlarged in order to make them intelligible. In addition, details of some components are omitted in certain cases when like reference marks are used because of their analogousness. The preferred embodiments described herein are illustrative and they are therefore considered as not restrictive.

### First Exemplary Embodiment

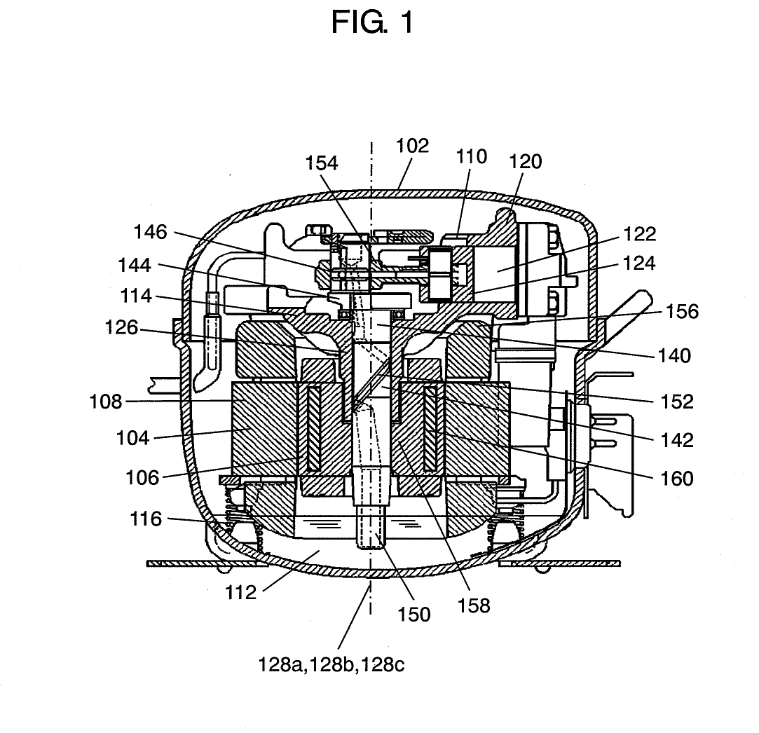

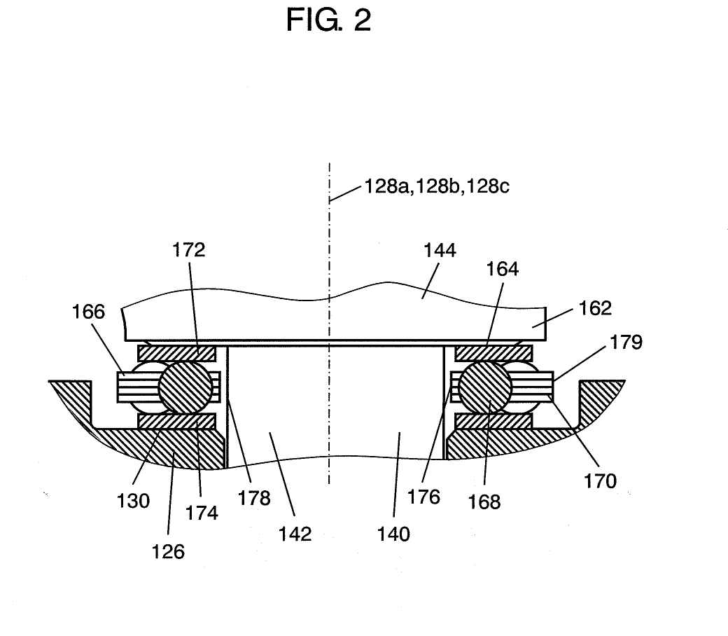

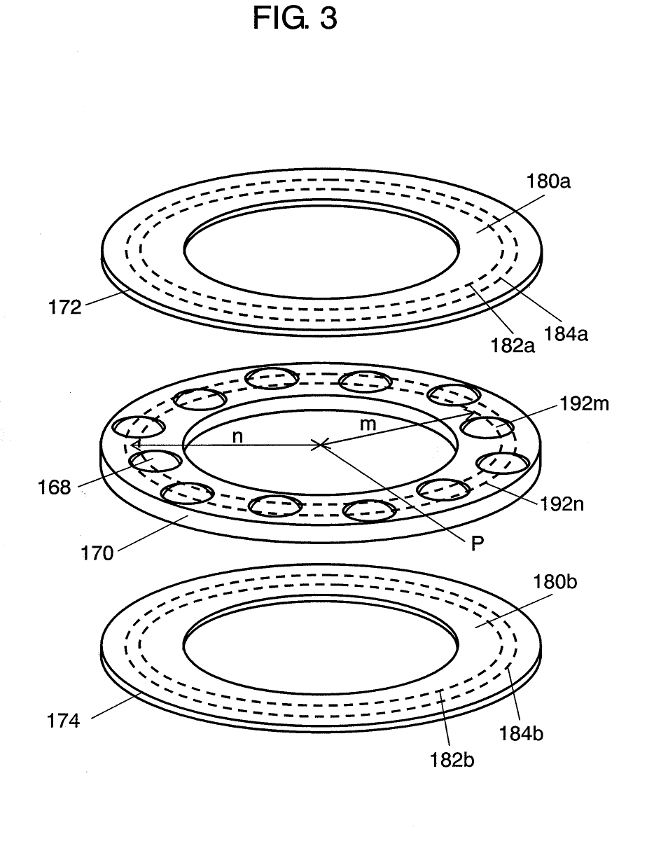

FIG. 1 is a vertical cross-sectional view of a hermetic compressor according to the first exemplary embodiment of the present invention, FIG. 2 is an enlarged view of an essential portion of the hermetic compressor of FIG. 1, and FIG. 3 is a perspective view of a thrust-ball bearing of this exemplary embodiment.

In FIG. 1 to FIG. 3, hermetically sealed container 102 houses motor element 108 formed of stator 104 and rotor 106 driven by an inverter power supply unit (not shown), compressor element 110 driven in a rotary motion by motor element 108, and lubricating oil 112 of low viscosity having a viscosity grade of VG5 stored in a bottom part thereof.

Motor element 108 and compressor element 110 are assembled into one unit to compose compressor mechanism 114. This compressor mechanism 114 is resiliently supported by a plurality of coil springs 116 within hermetically sealed container 102.

Description of the main structure of compressor element 110 is provided next.

Cylinder block 120, which composes compressor element 110, has cylindrical compression chamber 122 formed therein, and piston 124 is movably inserted in a manner to make reciprocating motion inside compression chamber 122. Cylinder block 120 is provided with main shaft bearing 126 formed on the lower portion of it, and thrust sliding surface 130 is formed on the upper portion of main shaft bearing 126 at generally perpendicular to axis 128a of main shaft bearing 126.

Shaft 140 has main shaft portion 142 and eccentric shaft portion 146 across flange portion 144. Main shaft portion 142 is axially supported by main shaft bearing 126 in a vertical direction. Shaft 140 has oil feeding mechanism 150, whose one end is in communication with lubricating oil 112 stored in hermetically sealed container 102, and oil feeding groove 152 in main shaft portion 142 for feeding a part of lubricating oil 112 drawn up by oil feeding mechanism 150 to thrust sliding surface 130. Eccentric shaft portion 146 and piston 124 are connected with connecting mechanism 154.

Motor element 108 is fixed to a lower part of cylinder block 120 with a bolt (not shown), and that it includes stator 104 provided with coil winding 156, and rotor 106 fixed to main shaft portion 142 of shaft 140 by thermal insertion method or the like.

Rotor 106 includes permanent magnet 160 made of a ferrite or a rare earth material assembled inside rotor core 158.

Shaft 140 has upper race receiving surface 164 provided on lower part 162 of flange portion 144 at generally perpendicular to axis 128b of main shaft portion 142. Thrust-ball bearing 166 is disposed between upper race receiving surface 164 and thrust sliding surface 130 for supporting weights of shaft 140 and rotor 106 in the direction of gravity.

Thrust-ball bearing 166 includes twelve balls 168, holder 170 made of a resin material for retaining balls 168, and upper race 172 and lower race 174 placed respectively on the top and the bottom of balls 168.

A certain space is provided between inner periphery 176 of holder 170 and outer periphery 178 of main shaft portion 142, and upper race 172 abuts upon upper race receiving surface 164 and lower race 174 abuts upon thrust sliding surface 130.

Among these twelve balls 168, six balls are placed in such positions that they leave two circular traces along tracks 182a and 184a on rolling surface 180a when they roll while in contact with upper race 172. The remaining six balls 168 are placed in other positions so that they leave two circular traces along tracks 182b and 184b on rolling surface 180b when they roll while in contact with lower race 174. In other words, six each of these twelve balls 168 are positioned around circle 192m of a radius “m” and another circle 192n of radius “n” from center “P” of holder 170.

Balls 168 are disposed alternately along circles 192m and 192n of holder 170 so that the adjoining balls 168 roll along different tracks 182a and 182b, or tracks 184a and 184b with respect to one another. In addition, any two of balls 168 located in the symmetrical positions about axis 128c of shaft 140 roll along the same track. That is, balls 168 are so arranged that any combination of two balls 168 in the symmetry positions about axis 128a, 128b and 128c roll along the same track.

The hermetic compressor constructed as above operates in a manner which is described hereinafter.

When motor element 108 is energized with an inverter power supply unit (not shown), rotor 106 rotates together with shaft 140. A rotating motion of eccentric shaft portion 146 is transferred to piston 124 through connecting mechanism 154 to make piston 124 move reciprocally inside compression chamber 122, and compressor element 110 perform a predetermined compressing operation.

The above operation introduces refrigerant gas into compression chamber 122 from a cooling system (not shown), and discharges the gas again to the cooling system after compression.

During this operation, shaft 140 draws up lubricating oil 112 by means of oil feeding mechanism 150 in main shaft portion 142, and lubricates individual sliding surfaces (not shown) with lubricating oil 112. A part of lubricating oil 112 is supplied to thrust sliding surface 130 via oil feeding groove 152 to lubricate thrust-ball bearing 166.

Weights of shaft 140 and rotor 106 are supported by thrust-ball bearing 166, and balls 168 roll between upper race 172 and lower race 174 when shaft 140 rotates. This makes smaller the torque to rotate shaft 140 as compared to other structure equipped with a thrust sliding bearing. As a result, this structure can improve efficiency of the compressor since it reduces a loss in the thrust bearing and decreases the input power.

Description of the sliding movement associated with thrust-ball bearing 166 is provided next.

Twelve balls 168 are divided into two six-ball groups, which are disposed along circles 192m and 192n of different radii from the center “P” of holder 170. Twelve balls 168 therefore roll along two tracks 182a and 184a on rolling surface 180a of upper race 172, and two tracks 182b and 184b on rolling surface 180b of lower race 174, when shaft 140 rotates.

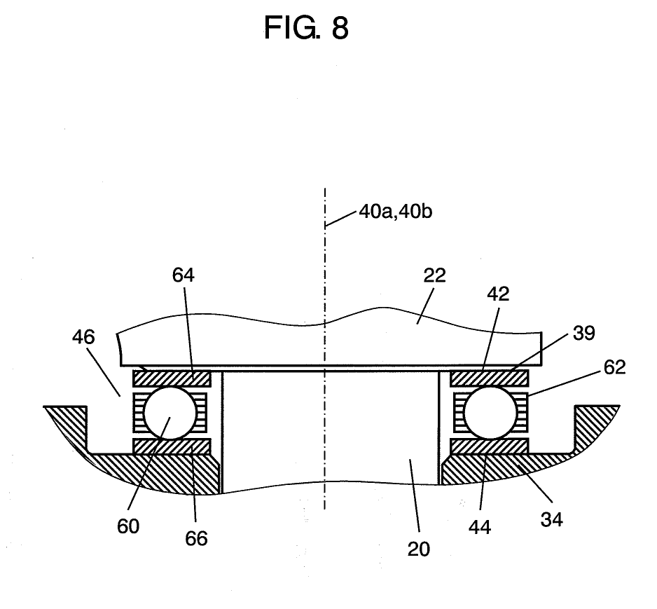

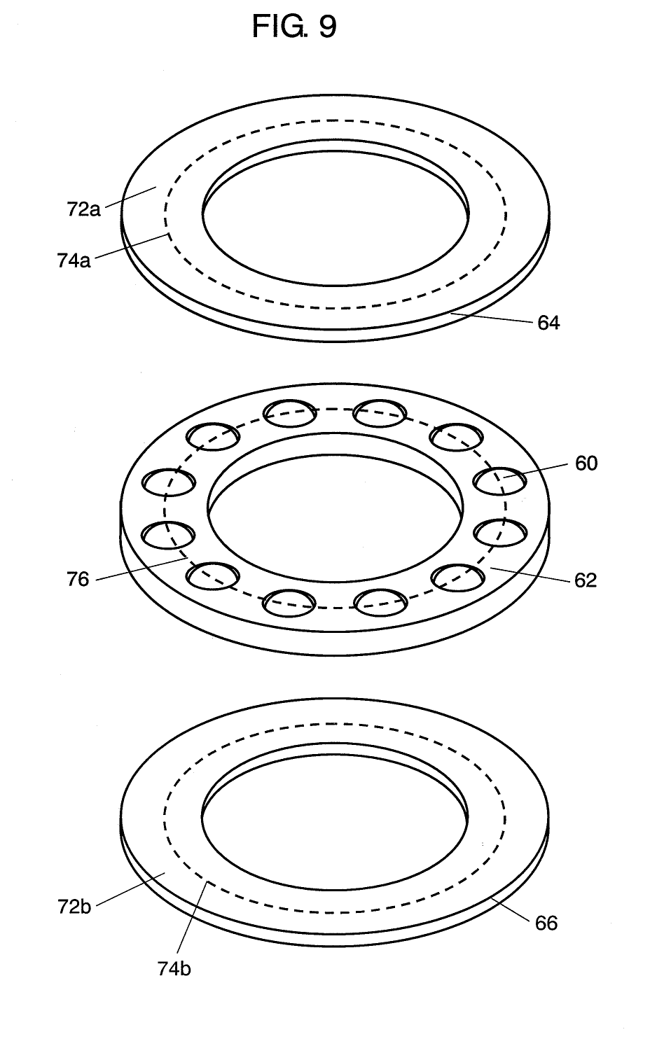

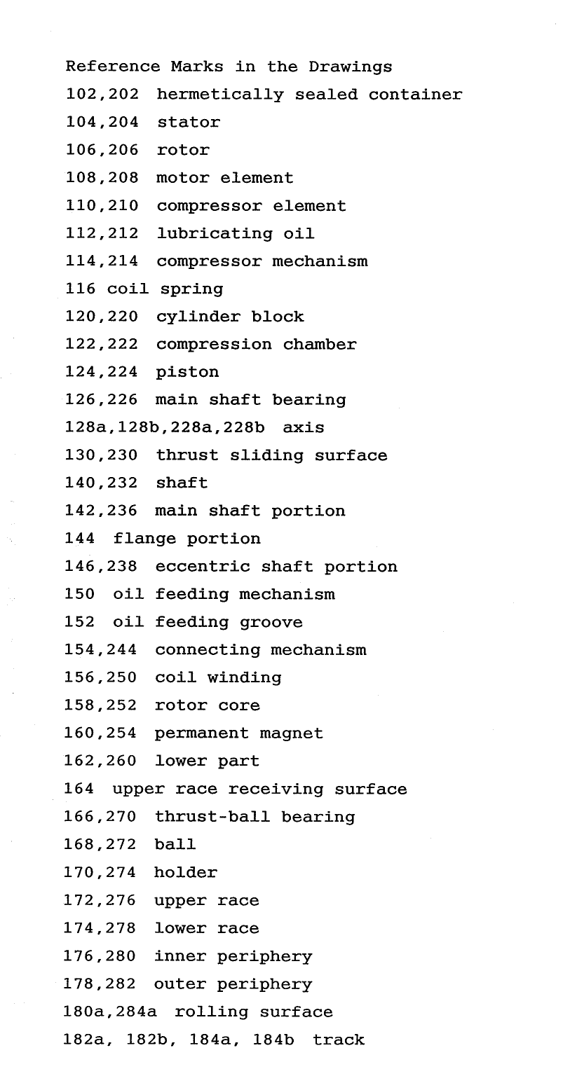

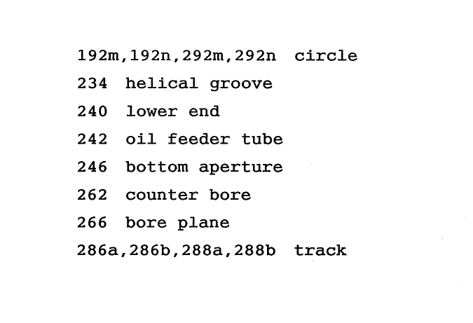

For this reason, this structure can substantially reduce the frequency and distance for the individual balls 168 to slide on tracks 182a, 182b, 184a and 184b to nearly one half, as compared to the conventional structure shown in FIG. 8 and FIG. 9, in which all balls 60 roll only along one track on rolling surface 72a of upper race 64 and another track 74b on rolling surface 72b of lower race 66, when the operating conditions are identical.

More specifically, the number of balls 168 that roll along each of different tracks 182a, 182b, 184a and 184b is six in this embodiment, whereas the number is twelve in the conventional structure. This fact shows a reduction by half even for just one example of comparing the number of balls 168 that roll on one track.

The structure can therefore reduce wearing of tracks 182a, 182b, 184a and 184b, and prevent balls 168 hard to roll in accordance with the wearing of tracks 182a, 182b, 184a and 184b. The present invention thus realizes the hermetic compressor of high efficiency and high reliability by reducing increase of the input power. The present invention also improves reliability of balls 168 as needless to note.

Six each of them balls 168 retained in holder 170 are positioned alternately along circles 192m and 192n of holder 170 so that adjoining balls 168 roll along different tracks 182a and 182b, or tracks 184a and 184b with respect to one another. This structure can substantially extend a time from when one of balls 168 rolls on a given point of the track till when the next ball 168 has passed the same point.

More specifically, the number of balls 168 that roll along each track is reduced by half from 12 balls to 6 balls, thereby extending to approximately two times the time from when one ball 168 rolls on a given point of the track till when the next ball 168 has passed the same point when the operating condition is identical.

Since lubricating oil 112 is supplied radially from the side of axis 128b to rolling surfaces 180a and 180b through oil feeding groove 152, tracks 182a, 182b, 184a and 184b are lubricated sufficiently with oil films formed thereon. This can thus help maintaining an excellent condition of the oil films on tracks 182a, 182b, 184a and 184b.

Accordingly, the oil films prevent increase in frictional resistance of the sliding interfaces between balls 168 and tracks 182a, 182b, 184a and 184b, so as to reduce wear and exfoliating phenomenon of tracks 182a, 182b, 184a and 184b. As a result, this structure can further improve efficiency and reliability by avoiding the increase of the input power.

Furthermore, since balls 168 located in the symmetrical positions with respect to each other about axis 128c of shaft 140 roll along the same circle among tracks 182a, 182b, 184a and 184b, centrifugal forces developed in balls 168 during rotation of thrust-ball bearing 166 can be counterbalanced between balls 168 of the symmetrically opposite positions.

As a result, this structure prevents holder 170 from shifting out of axis 128c, and avoids wear of inner periphery 176 of holder 170 attributed to collisions with outer periphery 178 of main shaft portion 142 as well as wear of outer periphery 179 of holder 170 attributed to collisions with adjacent parts such as main shaft bearing 126 of compressor mechanism 114, thereby achieving further improvement of the reliability.

This embodiment also uses lubricating oil 112 of low viscosity having a viscosity grade of VG5, for instance, to reduce losses in the sliding surfaces such as areas between main shaft portion 142 and main shaft bearing 126, so as to prevent an increase in frictional resistances of sliding interfaces between balls 168 and tracks 182a, 182b, 184a and 184b. This reduces wear and exfoliating phenomenon of tracks 182a, 182b, 184a and 184b, and further improves efficiency and reliability by avoiding an increase of the input power.

The high reliability can be maintained for the above reason especially when lubricating oil of low viscosity in a range of VG3 to VG8 is used. However, higher reliability can be ensured if the lubricating oil has a higher viscosity grade than VG8.

In addition, since this structure reduces the number of balls that roll along the individual tracks 182a, 182b, 184a and 184b on rolling surfaces 180a and 180b by one half as compared to the conventional structure, it can prevent wear of tracks 182a, 182b, 184a and 184b, as described above. This structure can thus prevent wear of rolling surfaces 180a and 180b even when it is operated at a high rotating speed or an operating frequency exceeding the power supply frequency such as 68 Hz to obtain a high refrigerating performance, since the structure prevents balls 168 hard to roll in accordance with the wearing of tracks 182a, 182b, 184a and 184b. The present invention can hence provide the hermetic compressor of high efficiency and high reliability by reducing the increase of the input power even in the high performance operation.

This invention also provides like function and advantageous effect as those of the first exemplary embodiment equipped with a permanent magnet, even when motor element 108 is an induction motor not having a permanent magnet, as needless to mention.

### Second Exemplary Embodiment

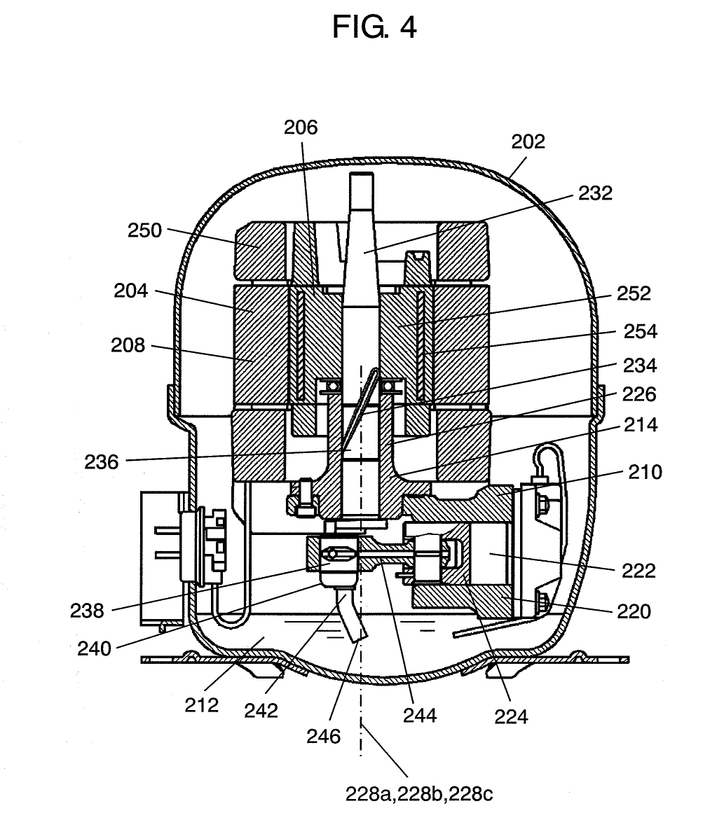

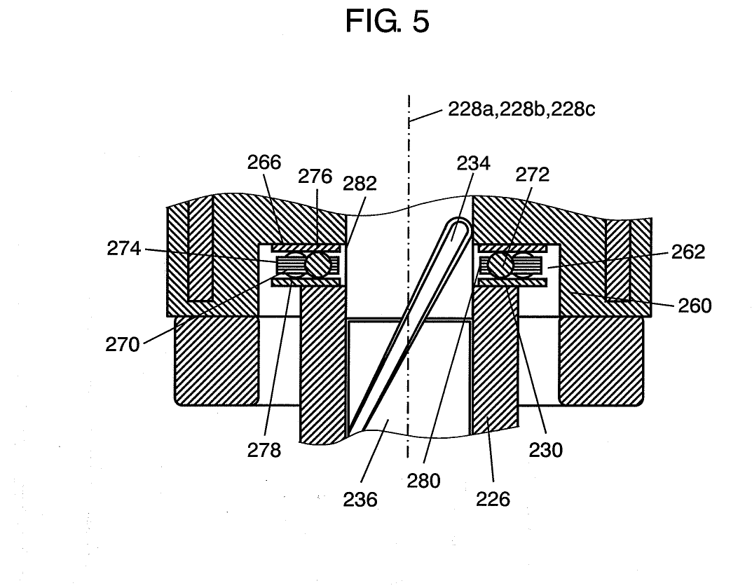

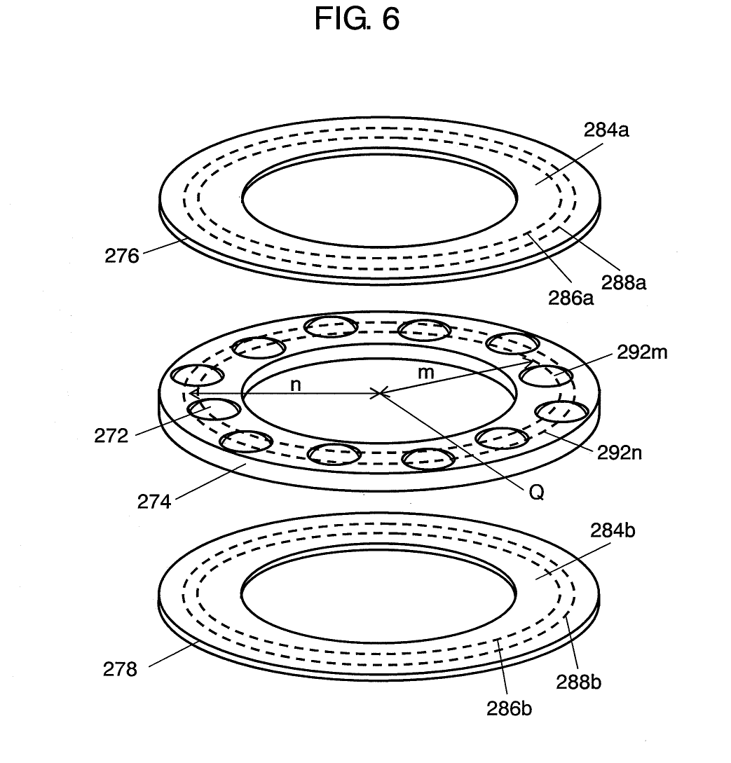

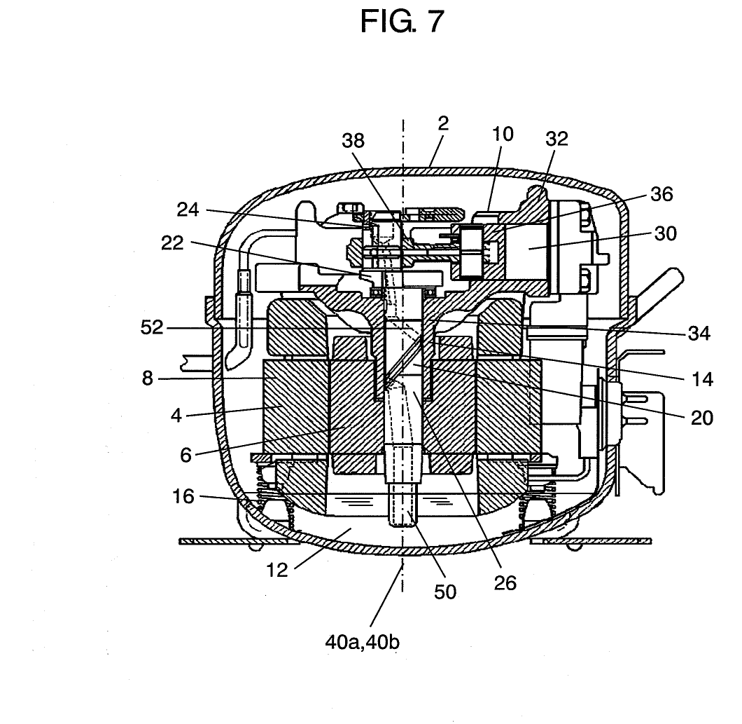

FIG. 4 is a vertical cross-sectional view of a hermetic compressor according to the second exemplary embodiment of this invention, FIG. 5 is an enlarged view of an essential portion of the hermetic compressor shown in FIG. 4, and FIG. 6 is a perspective view of a thrust-ball bearing of this exemplary embodiment.

In FIG. 4 to FIG. 6, hermetically sealed container 202 houses motor element 208 formed of stator 204 and rotor 206 driven by an inverter power supply unit (not shown), compressor element 210 driven in a rotary motion by motor element 208, and lubricating oil 212 of low viscosity having a viscosity grade of VG5 stored in a bottom part thereof.

Motor element 208 and compressor element 210 are assembled into one unit to compose compressor mechanism 214. This compressor mechanism 214 is resiliently supported by a plurality of coil springs (not shown) within hermetically sealed container 202.

Description of the main structure of compressor element 210 is provided next.

Cylinder block 220 that composes compressor element 210 has cylindrical compression chamber 222 formed therein, and piston 224 is movably inserted in a manner to make reciprocating motion within compression chamber 222. Cylinder block 220 is provided with main shaft bearing 226 fixed to the upper portion of it, and thrust sliding surface 230 is formed on the upper portion of main shaft bearing 226 at generally perpendicularly to axis 228a of main shaft bearing 226.

Shaft 232 includes main shaft portion 236, which is axially supported by main shaft bearing 226 in a vertical direction and has helical groove 234 on its outer periphery, and eccentric shaft portion 238 formed under main shaft portion 236. Oil feeder tube 242 formed of a steel tube is press-fitted to an oil feeding hole (not shown) provided at lower end 240 of eccentric shaft portion 238, and eccentric shaft portion 238 is connected with piston 224 by connecting mechanism 244.

One end of oil feeder tube 242 is in communication from lower end 240 of eccentric shaft portion 238 to helical groove 234, and oil feeder tube 242 is so curved that its bottom aperture 246 is open to lubricating oil 212 at the line extended from axis 228b of main shaft portion 236.

Motor element 208 is fixed to an upper part of cylinder block 220 with a bolt (not shown), and formed of stator 204 provided with coil winding 250, and rotor 206 fixed to main shaft portion 236 of shaft 232 by thermal insertion method or the like.

Rotor 206 includes permanent magnet 254 made of a ferrite or a rare earth material, which is assembled inside rotor core 252, and counter bore 262 (i.e., concavity) is formed in lower part 260 thereof.

Rotor 206 is provided with annularly shaped bore plane 266 formed in generally perpendicular to axis 228b in counter bore 262 (i.e., concavity) in lower part 260 thereof. Thrust-ball bearing 270 is disposed between bore plane 266 inside counter bore 262 and thrust sliding surface 230 for supporting the weights of shaft 232 and rotor 206 in the direction of gravity.

Thrust-ball bearing 270 includes twelve balls 272, holder 274 made of a resin material for retaining balls 272, and upper race 276 and lower race 278 placed respectively on the top and the bottom of balls 272.

A certain space is provided between inner periphery 280 of holder 274 and outer periphery 282 of main shaft portion 236, and upper race 276 abuts upon bore plane 266 and lower race 278 abuts upon thrust sliding surface 230.

Among these twelve balls 272, six balls roll while in contact with upper race 276 in a manner that they leave two circular traces along tracks 286a and 288a on rolling surface 284a. The other six balls among balls 272 roll while in contact with lower race 278 in a manner that they leave two circular traces along tracks 286b and 288b on rolling surface 284b. In other words, six each of these twelve balls 272 are positioned around circle 292m of a radius “m” and another circle 292n of radius “n” from center “Q” of holder 274.

Balls 272 are disposed alternately along circles 292m and 292n of holder 274 so that the adjoining balls roll along different tracks 286a and 286b, or tracks 288a and 288b with respect to one another. In addition, balls 272 are so arranged that any two of them located in the symmetrical positions about axis 228a, 228b and 228c roll along the same track. Here, axis 228c represents the axial center of shaft 232.

The hermetic compressor constructed as above operates in a manner which is described hereinafter.

When motor element 208 is energized with an inverter power supply unit (not shown), rotor 206 rotates together with shaft 232. A rotating motion of eccentric shaft portion 238 is transferred to piston 224 through connecting mechanism 244 to make piston 224 move reciprocally inside compression chamber 222, and compressor element 210 perform a predetermined compressing operation.

The above operation introduces refrigerant gas into compression chamber 222 from a cooling system (not shown), and discharges the gas again to the cooling system after compression.

In this embodiment, one end of oil feeder tube 242 is press-fitted to lower end 240 of eccentric shaft portion 238, and bottom aperture 246 is curved toward the line extended from axis 228b of main shaft portion 236. Therefore, oil feeder tube 242 draw up lubricating oil 212 by the centrifugal force produced by rotation of shaft 232, and lubricates the individual sliding surfaces (not shown) while a part of lubricating oil 212 is supplied from helical groove 234 to thrust sliding surface 230 to lubricate thrust-ball bearing 270.

Weights of shaft 232 and rotor 206 are supported by thrust-ball bearing 270, and balls 272 roll between upper race 276 and lower race 278 while shaft 232 is rotating. This makes smaller the torque to rotate shaft 232 as compared to other structure equipped with a thrust sliding bearing. As a result, this structure can improve the efficiency since it reduces a loss in the thrust bearing and decreases the input power.

Description of the sliding movement associated with thrust-ball bearing 270 is provided next.

Twelve balls 272 are divided into two six-ball groups, which are disposed along circles 292m and 292n of different radii from the center “Q” of holder 274. Twelve balls 272 therefore roll along two tracks 286a and 288a on rolling surface 284a of upper race 276 and two tracks 286b and 288b on rolling surface 284b of lower race 278, when shaft 232 rotates.

For this reason, this structure can substantially reduce the frequency and distance for the individual balls 272 to slide on tracks 286a, 286b, 288a and 288b to nearly one half, as compared to the conventional structure shown in FIG. 8 and FIG. 9, in which all balls 60 roll only along one track on rolling surface 72a of upper race 64 and another track 74b on rolling surface 72b of lower race 66, when the operating condition is identical.

More specifically, the number of balls 272 that roll along each of different tracks 286a, 286b, 288a and 288b is six in this embodiment, whereas the number is twelve in the conventional structure, and this fact shows a reduction by half even for just one example of comparing the number of balls 272 that roll on one track.

The structure can therefore reduce the wearing of tracks 286a, 286b, 288a and 288b, and prevent balls 272 hard to roll in accordance with the wearing of tracks 286a, 286b, 288a and 288b. The present invention thus realizes the hermetic compressor of high efficiency and high reliability by reducing the increase of the input power. The present invention also improves the reliability of balls 272 as needless to note.

Six each of balls 272 retained in holder 274 are positioned alternately along circles 292m and 292n of holder 274 so that adjoining balls 272 roll along different tracks 286a and 286b, or tracks 288a and 288b with respect to one another. This structure can substantially extend a time from when one of balls 272 rolls on a given point of the track till when the next ball 272 has passed the same point.

More specifically, the number of balls 272 that roll along each track is reduced by half from 12 balls to 6 balls, thereby extending to approximately two times the time from when one ball 272 rolls on a given point of the track till when the next ball 272 has passed the same point if the operating condition is identical.

Since lubricating oil 212 is supplied radially from the side of axis 228b to rolling surfaces 284a and 284b through helical groove 234, tracks 286a, 286b, 288a and 288b are lubricated sufficiently with oil films formed thereon. This can thus help maintain an excellent condition of the oil films on tracks 286a, 286b, 288a and 288b.

Accordingly, the oil films prevent an increase in frictional resistance of the sliding interfaces between balls 272 and tracks 286a, 286b, 288a and 288b, so as to reduce wear and exfoliating phenomenon of tracks 286a, 286b, 288a and 288b. As a result, this structure can further improve the efficiency and reliability by avoiding an increase of the input power.

Furthermore, since balls 272 located in the symmetrical positions with respect to each other about axis 228c of shaft 232 roll along the same circle among tracks 286a, 286b, 288a and 288b, centrifugal forces developed in balls 272 during rotation of thrust-ball bearing 270 can be counterbalanced between balls 272 of the symmetrically opposite positions.

As a result, this structure prevents holder 274 from shifting out of axis 228c, and avoids wearing of inner periphery 280 of holder 274 attributed to collisions with outer periphery 282 of main shaft portion 236 as well as wearing of outer periphery 282 of holder 274 attributed to collisions with parts of compressor mechanism 214 such as main shaft bearing 226, thereby achieving further improvement of the reliability.

This embodiment also uses lubricating oil 212 of low viscosity having a viscosity grade of VG5, for instance, in order to reduce losses in the sliding surfaces such as areas between main shaft portion 236 and main shaft bearing 226, so as to prevent an increase in frictional resistances of sliding interfaces between balls 272 and tracks 286a, 286b, 288a and 288b. This reduces wear and exfoliating phenomenon of tracks 286a, 286b, 288a and 288b, and further improves the efficiency and reliability by avoiding an increase of the input power.

The high reliability can be maintained for the above reason especially even when lubricating oil of low viscosity in a range of VG3 to VG8 is used. However, higher reliability can be ensured if the lubricating oil has a higher viscosity grade than VG8.

In addition, since this structure reduces the number of balls that roll along the individual tracks 286a, 286b, 288a and 288b on rolling surfaces 284a and 284b by one half as compared to the conventional structure, it can prevent wear of tracks 286a, 286b, 288a and 288b, as described above. This structure can thus prevent wearing of rolling surfaces 284a and 284b even when it is operated at a high rotating speed exceeding the power supply frequency such as 68 Hz to obtain a high refrigerating performance, since the structure prevents balls 272 hard to roll in accordance with the wearing of tracks 286a, 286b, 288a and 288b. The present invention can hence provide the hermetic compressor of high efficiency and high reliability by minimizing increase of the input power even in the high performance operation.

This invention also provides like function and advantageous effect as those of the second exemplary embodiment equipped with a permanent magnet, even when motor element 208 is an induction motor not having a permanent magnet, as needless to mention.

### INDUSTRIAL APPLICABILITY

As described above, the hermetic compressor of the present invention includes a thrust-ball bearing having a plurality of balls so that they roll along at least two tracks. The present invention can thus provide the hermetic compressors with high efficiency and high reliability by minimizing increase of the input power. The hermetic compressors are therefore useful for such applications as vending machines, freezer showcases and dehumidifiers besides refrigeration units such as refrigerators and freezers.

1. A hermetic compressor comprising:
a hermetically sealed container storing lubricating oil therein;
a motor element provided with a stator and a rotor, and contained in the container; and
a compressor element driven by the motor element and contained in the container, the compressor element having:
a shaft having the rotor fixed to a vertically extending main shaft portion thereof;
a main shaft bearing axially supporting the main shaft portion of the shaft; and
a compression chamber whose capacity varies with rotation of the shaft; and
a thrust-ball bearing having a plurality of balls and a holder for retaining the balls at a thrust sliding surface for supporting weights of the shaft and the rotor in a direction of gravity,
wherein the balls are arranged in a manner to roll along at least two tracks.

2. The hermetic compressor of claim 1,
wherein the balls are arranged in a manner that the adjoining balls roll along different tracks one another.

3. The hermetic compressor of claim 1,
wherein the balls located in symmetrical positions about an axis of the shaft roll along the same track.

4. The hermetic compressor of claim 1,
wherein the lubricating oil has a viscosity ranging from VG3 to VG8.

5. The hermetic compressor of claim 1,
wherein the rotor is driven with an operating frequency exceeding at least a power supply frequency.

6. The hermetic compressor of claim 2,
wherein the balls located in symmetrical positions about an axis of the shaft roll along the same track.

7. The hermetic compressor of claim 2,
wherein the lubricating oil has a viscosity ranging from VG3 to VG8.

8. The hermetic compressor of claim 2,
wherein the rotor is driven with an operating frequency exceeding at least a power supply frequency.
